(19) United States
(12) Patent Application Publication
(10) Pub. No.: US 2013/0148480 A1
(43) Pub. Date: Jun. 13, 2013

(54) ESCAPEMENT SYSTEM FOR A TIMEPIECE

(71) Applicants: Christian Charbon, Chezard-St-Martin (CH); Yves Winkler, Schmitten (CH); Marco Verardo, Les Bois (CH)

(72) Inventors: Christian Charbon, Chezard-St-Martin (CH); Yves Winkler, Schmitten (CH); Marco Verardo, Les Bois (CH)

(73) Assignee: The Swatch Group Research and Development Ltd., Marin (CH)

(21) Appl. No.: 13/703,837

(22) PCT Filed: Jun. 22, 2011
(86) PCT No.: PCT/EP2011/060511

§ 371 Date: Feb. 26, 2013

(30) Foreign Application Priority Data
Jun. 22, 2010 (EP) 10166938.0

(51) Int. Cl. G04B 15/00

(52) U.S. Cl. CPC G04B 15/00
USPC 368/132

(57) ABSTRACT

An escapement system that includes an anchor fitted with a fork configured to cooperate with a pin mounted on a disc and a shaft including arms configured to receive pallets to cooperate with at least one escape wheel. A part of the escapement system is made from an at least partially amorphous metal alloy.

The present invention relates to an escapement system. This escapement system comprises an anchor fitted with a fork intended to cooperate with a pin mounted on a disc and a shaft comprising arms intended to receive pallets in order to cooperate with at least one escape wheel.

The technical field of the invention is the technical field of fine mechanics and more particularly watchmaking.

### TECHNOLOGICAL BACKGROUND

Timepieces comprise an energy source such as the spring barrel that supplies energy to the piece and in particular to the gear trains. These wheel trains cooperate with the escapement system via the escape wheel. The rotation of the latter is adjusted by the anchor of the escapement system, the pulses of which are supplied by the spring balance. The escapement system comprises an anchor mounted to pivot on an axis. This anchor comprises a lever fitted on a first end with a fork intended to cooperate with a pin mounted on a disc and fitted on a second end with arms intended to receive pallets in order to cooperate with the escape wheel. During its operation the anchor pivots on its axis in such a manner that the pallets of the arms come into contact with the teeth of the escape wheel in order to control the rotation of the wheel trains.

At present, the efficiency of the escapement is relatively poor. In fact, the operation of the escapement system includes friction, is subject to shocks and to energy dissipation in the materials forming the wheel and the anchor in particular. One material used is 15P or 20AP steel, for example. These materials are crystalline materials. One disadvantage of components made of crystalline metal is their low mechanical strength when high stresses are applied. In fact, each material is characterised by its Young's modulus E also referred to as modulus of elasticity (generally expressed in GPa), which characterises its resistance to deformation. Each material is also characterised by its elastic limit σₑ (generally expressed in GPa) that represents the stress beyond which the material is plastically deformed. It is thus possible, with given dimensions, to compare the materials by establishing for each the ratio of their elastic limit to their Young's modulus σₑ/E, said ratio being representative of the elastic deformation of each material. Thus, the higher this ratio is, the higher the limit of elastic deformation of the material. Typically, for an alloy such as Cu—Be the Young's modulus E is equal to 130 GPa and the elastic limit σₑ is equal to 1 GPa, which gives a σₑ/E ratio in the order of 0.007, i.e. a low ratio. The pieces made of crystalline metal or alloy consequently have a limited capability for elastic deformation.

In addition, the efficiency of the escapement is linked to its energy restitution factor during shocks, wherein these shocks are the shocks between the pallets of the anchor of the escape wheel and the shocks between the pin of the disc and the fork entry.

The kinetic energy accumulated during the displacement of the anchor or the escape wheel is dependent on the moment of inertia, which is a function of the mass and the radius of gyration, thus of the dimensions.

As the maximum energy that can be stored elastically is calculated as being the ratio between the square of the elastic limit σₑ, on the one hand, and the Young's modulus E, on the other, the low elastic limit of crystalline metals results in a low level of energy storage capacity. 15P or 20AP steels are dense and the anchors and escape wheels therefore have a high mass. The moment of inertia is therefore high and the kinetic energy accumulated during the displacements of the anchor and the escape wheel is thus significant.

However, since crystalline metals cannot store a large quantity of energy, energy losses occur during shocks of the lifts/teeth of the escape wheel and during shocks between the pin of the disc and the fork entry.

Consequently, the not insubstantial portion of energy delivered by the spring barrel is lost during operation of the timepiece, thus reducing its power reserve.

Moreover, watchmaking traditionally uses quenched and tempered carbon, sulphur and lead steels that have good machinability and very good mechanical properties, but are magnetic. Non-magnetic alternatives are rare and are generally more difficult to machine and have less favourable mechanical properties.

Precision gear trains, in particular for timepieces made from amorphous metal, are also known from patent document EP 1 696 153.

This document relates to gear trains that cooperate with one another by interlocking. What is meant by this is that in the case of two gear trains cooperating with one another, the teeth of each gear train enter the space between the teeth of the other gear train. Therefore, there is a process of pushing and sliding of the teeth to cause the gear trains to rotate. This sliding process involves having a material that is both hard and strong and has very smooth surfaces to prevent friction that cause losses in efficiency and premature wear.

An escape wheel is different from a classic gear train since it does not work according to the same principle. In fact, such an escape wheel is driven by the barrel spring and its rotation is controlled by the escapement system, which by way of the spring balance, the anchor and the pallets successively releases and stops the rotation of said wheel. Thus, after the release and pulse phase the tooth of the escape wheel comes heavily to rest against the locking face of the pallet of the anchor. These heavy shocks repeated with each pulse involve a very different stress on the escape wheel compared to a gear train.

Such an escape wheel must therefore be made from a material that has a high elastic limit to prevent any plastic deformation during these repeated shocks. Moreover, during the pulse phase when the tooth of the escape wheel is located on the pulse face of the anchor, the wheel must transfer a maximum amount of energy to the anchor so that the latter can return it to the balance. Therefore, it is important that the material used for the escape wheel has an energy restitution factor that is as high as possible to minimise the losses and therefore increase the efficiency of the system.

It is therefore understood that the person skilled in the art seeking to configure an escape wheel with improved efficiency is not encouraged to use documents relating to classic gear trains that use materials, wherein the desired properties are different from those desired for escape wheels.

### SUMMARY OF THE INVENTION

The aim of the invention is to overcome the disadvantages of the prior art by proposing to provide an escapement system with a higher efficiency that is easier to form.

On this basis, the invention relates to the aforementioned escapement system that is characterised in that at least one part of the escapement system is made from an at least partially amorphous metal alloy.

A first advantage of the present invention is to enable the escapement system to have a better energy restitution factor than current escapements. In fact, an amorphous metal is characterised by the fact that during its formation the atoms forming these amorphous materials are not arranged according to a particular structure as is the case with crystalline materials. Therefore, even if the Young's modulus E of a crystalline metal and that of an amorphous metal are substantially identical, their elastic limits σₑ are different. An amorphous metal is thus distinguished by a higher elastic limit σ_{eA} than that σ_{eC} of the crystalline metal by a factor of two or three. The elastic limit σₑ is increased to enable the σₑ/E ratio to be increased so that the stress limit beyond which the material does not return to its initial form increases, and above all so that the maximum energy that can be stored and restored elastically increases.

Another advantage of the present invention is to enable shaping to be achieved with great ease to allow pieces with complicated shapes to be made with higher precision. In fact, amorphous metals have the particular characteristic of softening while remaining amorphous for a certain period in a given temperature range [Tg-Tx] particular to each alloy (with Tx: crystallisation temperature and Tg: glass transition temperature). It is thus possible to shape them under a relatively low pressure stress and at quite a low temperature, thus allowing the use of a simplified process compared to a machining and drawing operation. In the case of shaping by moulding, the use of such a material additionally enables fine geometries to be reproduced with high precision since the viscosity of the alloy decreases greatly as a function of the temperature in the temperature range [Tg-Tx] and the alloy thus moulds to all the details of a negative. Negative is understood to mean a mould that has a profile in the cavity that is complementary to that of the desired component. This then makes it easy to form complex designs in a precise manner.

Advantageous embodiments of this escapement system are the subject of the dependent claims.

In an first advantageous embodiment, the anchor is made from an at least partially amorphous metal alloy.

In a variant of the first advantageous embodiment only a part of the anchor such as the fork, for example, is made from an at least partially amorphous metal alloy.

In a second advantageous embodiment the pallets of the anchor are made from an at least partially amorphous metal alloy.

In a third advantageous embodiment the pallets of the anchor and the anchor are made from one and the same piece.

In another advantageous embodiment the escape wheel is made from an at least partially amorphous metal alloy.

In another advantageous embodiment the disc is made from an at least partially amorphous metal alloy.

In another advantageous embodiment at least one part of the escapement system comprises recesses in order to reduce the moment of inertia of this part.

In another advantageous embodiment the recesses are passages.

In another advantageous embodiment at least one part of the escapement system comprises narrowed zones in order to reduce the moment of inertia of this part.

In another advantageous embodiment said anchor, said escape wheel and said disc are made from an at least partially amorphous metal alloy.

In another advantageous embodiment the material is completely amorphous.

In another advantageous embodiment the material is completely metallic.

In another advantageous embodiment said metal alloy is non-magnetic.

### BRIEF DESCRIPTION OF THE FIGURES

The aims, advantages and characteristics of the escapement system according to the present invention will be become clearer from the following detailed description of at least one embodiment of the invention given solely as a non-restrictive example and illustrated by the attached drawings, wherein:

FIGS. 1 and 2 schematically show an escapement system for a timepiece according to the invention.

### DETAILED DESCRIPTION

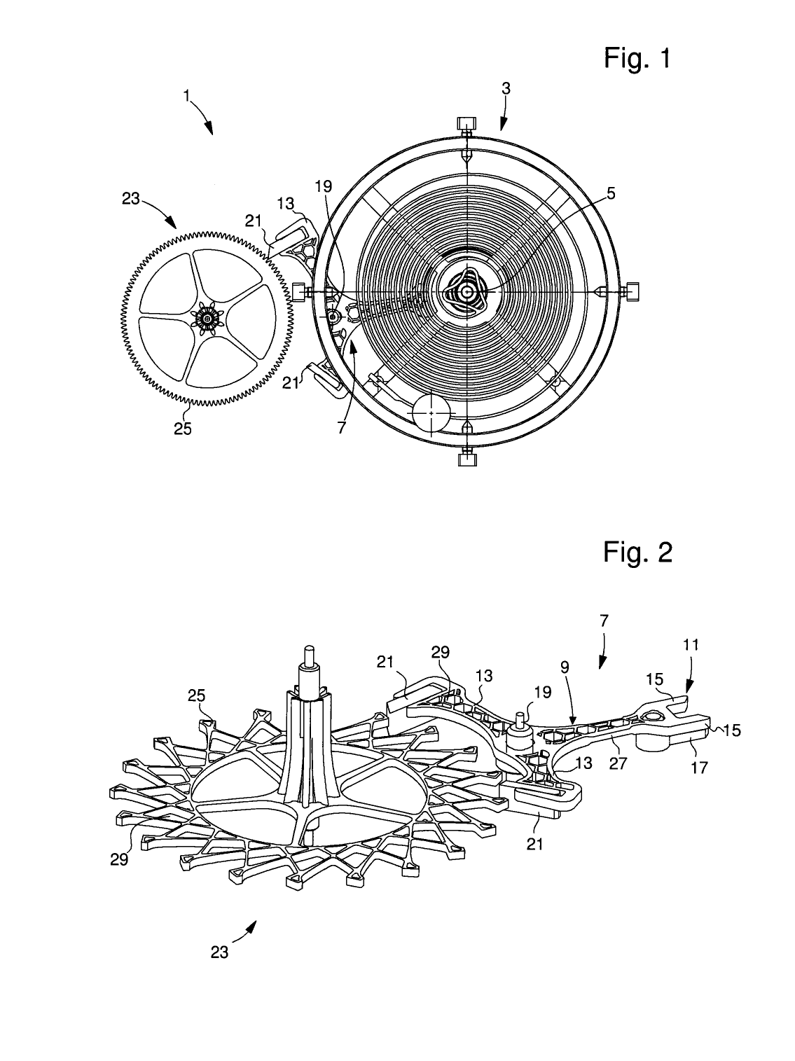

FIGS. 1 and 2 show an escapement system 1 with its resonator 3, i.e. the spring balance. Usually, the resonator 3 cooperates with the escapement system 1 with the assistance of a disc 5 mounted on the balance axis. The escapement system 1 comprises a Swiss anchor 7 formed by a main face (visible in FIG. 1) in projection. The Swiss anchor 7 is principally formed by a lever 9 connecting the fork 11 and the arms 13. The fork 11 comprises two horns 15 facing one another, below which a guard pin 17 is mounted to respectively cooperate with a pin fixed to said disc 5 of the balance axis and the bottom part of said disc 5.

Between the two arms 13 the lever 9 receives a rod 19 intended to rotatably mount the anchor between a bridge and the bottom plate of the movement. Finally, a pallet 21 intended to come into contact with the escape wheel 23 by means of its teeth 25 is fitted on each arm 13. As an example, the pallets can be formed from synthetic rubies. Of course, the present invention could also be used for the coaxial type of escapement as in watchmaking.

According to the invention at least one part of the escapement system 1, i.e. the disc 5 or the anchor 7 or the escape wheel 23, is preferably made from an at least partially amorphous metal alloy. This metal alloy can contain a precious metal element such as gold, platinum, palladium, rhenium, ruthenium, rhodium, silver, iridium or osmium. An at least partially amorphous metal alloy is understood to mean that the material is capable of solidifying at least partially in amorphous form.

It is naturally understood that in a particular configuration all the parts of the escapement system 1 are made from an at least partially amorphous metal alloy. However, these parts can be made from different amorphous materials. Moreover, the metal alloy or the metal can be completely amorphous.

It is also conceivable that only a part of the anchor 7 such as the fork 11, for example, is made from an at least partially amorphous metal alloy.

Moreover, it is conceivable that this at least partially amorphous metal alloy is non-magnetic so that said escapement system 1 is insensitive to external magnetic interferences.

The advantage of amorphous metal alloys results from the fact that during its formation the atoms forming these amorphous materials are not arranged according to a particular structure as is the case with crystalline materials. Therefore, even if the Young's modulus E of a crystalline metal and that of an amorphous metal are substantially identical, their elastic limits σₑ are different. An amorphous metal is thus distinguished by a higher elastic limit σ_{eA} than that σ_{eC} of the crystalline metal by a factor essentially equal to two. A higher elastic limit σₑ thus means that a piece made of amorphous metal alloy or amorphous metal is plastically deformed under a higher stress than the same piece made of crystalline metal.

The losses of an escapement system 1 are linked to friction between the pallets 21 of the anchor 7 and the teeth 25 of the escape wheel 23 during the drive phase and between the pin of the disc 5 and the entry of the fork and to the shocks between the teeth 25 of the escape wheel 23 of the pallets 21 of the anchor 7 during the drop phase.

The losses linked with the shocks between the teeth 25 of the escape wheel 23 and the pallets 21 of the anchor 7 during the drop phase are dependent on the kinetic energy. This kinetic energy that is accumulated during operation of the escapement system 1 is dependent on the moment of inertia. This moment of inertia is a function of the mass and the radius of gyration. In the case of an escape wheel, the larger the diameter or the greater the mass of this wheel 23, the more the moment of inertia of said wheel 23 will increase. This increase in the moment of inertia results in an increase in the kinetic energy of said escape wheel 23. Therefore, when shocks occur between the teeth 25 of the escape wheel 23 and the pallets 21 of the anchor 6 during the drop phase, the accumulated kinetic energy is dissipated without being transferred. Thus, a reduction in the kinetic energy of the wheel 23 is a solution to reduce these losses. Hence, a decrease in mass or in the diameter of said escape wheel 23 causes a decrease in the moment of inertia, and therefore in the kinetic energy of said escape wheel 23.

An important characteristic of the material used for the production of such pieces is therefore to maximise the specific strength, which is defined by the ratio of the elastic limit to the density. In the case of crystalline alloys the maximum specific strength is in the order of 200-250 MPa*cm³/g. In contrast, the specific strength of amorphous alloys is in the order of 300-400 MPa*cm³/g.

Thus, it is possible for a given piece geometry and a given necessary mechanical strength to use an amorphous alloy that has a density lower than that of the crystalline alloy meeting the same criterion. Consequently, the moment of inertia of the system will be reduced and its operation improved.

Another solution consists of reducing the mass of the piece by removing material, preferably in the zones contributing most to the moment of inertia, i.e. in the parts furthest away from the rotation axis of the piece. It is possible, for example, to form recesses 29, whether as passages or not, and/or to locally reduce the thickness 27 of the piece. An amorphous alloy with a mechanical strength higher than that of the crystalline alloy will be chosen to compensate for this reduction in material. Given the advantageous specific strength of amorphous alloys, the density of the amorphous alloy could be chosen to be equal to or even slightly less then that of the crystalline alloy, and consequently the moment of inertia of the system 1 will be reduced.

A third possibility is to reduce the dimensions of the elements of the escapement system 1 such as the anchor 7 or the wheel 23 or the disc 5. By choosing an amorphous alloy with a higher mechanical strength than the crystalline alloy used for the current dimensions, this reduction in dimensions and in mass will not cause any reduction in mechanical strength of the escapement system 1. However, since the specific strength of amorphous alloys is higher compared to crystalline alloys, the density of the amorphous alloy chosen could be equal to or less than that of the crystalline alloy used for the standard piece, and consequently the moment of inertia as well as the space requirement of the system 1 could be reduced.

It is preferred to choose to reduce the mass of the parts of the escapement system 1 that are made of amorphous metal or metal alloy. This enables the same space requirement to be retained as for an escapement system 1 made of crystalline material, and therefore enables the standard dimensions to be retained while having a better resistance to stresses.

To form such an escapement system made of amorphous metal it is advantageous to use the properties of the amorphous metal for its shaping. In fact, the amorphous metal allows shaping to be achieved with great ease to enable pieces with complicated shapes to be made with higher precision. This is due to the particular characteristics of the amorphous metal, which can soften while remaining amorphous over a certain period in a given temperature range [Tg-Tx] specific to each alloy (for example, for an alloy Zr_{41.24}Ti_{13.75}Cu_{12.5}Ni₁₀Be_{22.5}, Tg=350° C. and Tx=460° C.). It is thus possible to shape them with a relatively low stress and at a moderate temperature, thus allowing the use of a simplified process such as hot forming. The use of such a material additionally enables fine geometries to be reproduced with high precision since the viscosity of the alloy decreases significantly as a function of the temperature in the temperature range [Tg-Tx] and the alloy thus moulds to all the details of the negative. For example, in the case of a platinum-based material, shaping occurs at around 300° C. with a viscosity reaching 10³ Pa.s with a force of 1 MPa instead of a viscosity of 10¹² Pa.s at the temperature Tg. The use of dies has the advantage of creating high-precision pieces in three dimensions, which cutting or stamping does not permit.

A process used is the hot forming of an amorphous preform. This preform is obtained by melting the metallic elements intended to form the amorphous alloy in an oven. Once these elements are melted, they are cast in the form of a semi-finished product, then cooled rapidly in order to retain the at least partially amorphous state. Once the preform is made, the hot forming is conducted in order to obtain a final piece. This hot forming is conducted by pressing in a temperature range of between its glass transition temperature Tg and its crystallisation temperature Tx for a determined period to retain a completely or partially amorphous structure. This is done with the aim of retaining the elastic properties characteristic of amorphous metals.

Typically, for the alloy Zr_{41.2}Ti_{13.8}Cu_{12.5}Ni₁₀Be_{22.5} and with a temperature of 440° C., the pressing period should not exceed about 120 seconds. Thus, hot forming allows the at least partially amorphous initial state of the preform to be retained. The different steps of the final forming of an element of the escapement system are therefore:

a) heating dies having a negative form of the element of the escapement system 1 to a chosen temperature,

b) inserting the amorphous metal preform between the hot dies,

c) applying a closing force to the dies in order to replicate the geometry thereof on the amorphous metal preform,

d) waiting for a chosen maximum period,

e) opening the dies,

f) rapidly cooling the element of the escapement system to below Tg so that the material retains its at least partially amorphous state, and

g) removing the element of the escapement system 1 from the dies.

These characteristics of ease of shaping, precision of the piece obtained and very favourable reproducibility are thus very useful for obtaining variable thicknesses and recesses. This ease of shaping also allows complex pieces to be easily formed such as e.g. the disc 5 of the escapement system 1 with its pin.

Moreover, the possibility of easy shaping of complex pieces specifically allows complicated designs to be created. This can also be of interest for shaping teeth of the escape wheel and the shaping of the anchor in order to improve cooperation between the escape wheel and the anchor.

It will be understood that various modifications and/or improvements and/or combination obvious for the person skilled in the art can be applied to the different embodiments of the invention discussed above without departing from the framework of the invention defined by the attached claims.

It will, of course, be understood that the elements of the escapement system can be formed by casting or by injection. This process consists of casting the alloy obtained by melting the metallic elements in a mould having the shape of the final piece. Once the mould has been filled, it is rapidly cooled to a temperature lower than T_{g} to prevent crystallisation of the alloy and thus obtain a system 1 made of amorphous or partially amorphous metal.

It is, of course, also conceivable that the pallets 21 of the anchor 7 are made from amorphous metal or alloy. These pallets 21 can be made only in one piece with said anchor or be moulded on after production of the anchor 7. It is then conceivable that the pallets 21 and the anchor 7 are made of amorphous metal or alloy different from one another.

1-13. (canceled)

14. An escapement system comprising:
an anchor fitted with a fork configured to cooperate with a pin mounted on a disc; and
a shaft comprising arms configured to receive pallets to cooperate with at least one escape wheel;
wherein at least one part of the escapement system is made from an at least partially amorphous metal alloy.

15. The escapement system according to claim 14, wherein the anchor is made from an at least partially amorphous metal alloy.

16. The escapement system according to claim 14, wherein the pallets of the anchor are made from an at least partially amorphous metal alloy.

17. The escapement system according to claim 15, wherein the pallets of the anchor are made from an at least partially amorphous metal alloy.

18. The escapement system according to claim 14, wherein the pallets of the anchor and the anchor form one and a same piece.

19. The escapement system according to claim 15, wherein the pallets of the anchor and the anchor form one and a same piece.

20. The escapement system according to claim 16, wherein the pallets of the anchor and the anchor form one and a same piece.

21. The escapement system according to claim 17, wherein the pallets of the anchor and the anchor form one and a same piece.

22. The escapement system according to claim 14, wherein the escape wheel is made from an at least partially amorphous metal alloy.

23. The escapement system according to claim 14, wherein the disc is made from an at least partially amorphous metal alloy.

24. The escapement system according to claim 14, wherein at least one part of the escapement system comprises recesses to reduce moment of inertia of the at least one part.

25. The escapement system according to claim 24, wherein the recesses are passages.

26. The escapement system according to claim 14, wherein at least one part of the escapement system comprises narrowed zones to reduce moment of inertia of the at least one part.

27. The escapement system according to claim 14, wherein said anchor, said escape wheel, and said disc are made from an at least partially amorphous metal alloy.

28. The escapement system according to claim 14, wherein the material is completely amorphous.

29. The escapement system according to claim 14, wherein the material is completely metallic.

30. The escapement system according to claim 14, wherein said metal alloy is non-magnetic.
